(19) United States
(12) Patent Application Publication
(10) Pub. No.: US 2007/0132252 A1
(43) Pub. Date: Jun. 14, 2007

(54) Device for picking up animal waste, adaptable or integrated to a leash equipped with a reel

(76) Inventor: Remus Ovidiu Cioloboc, Vire (FR)

Correspondence Address: HEDMAN & COSTIGAN P.C., 1185 AVENUE OF THE AMERICAS, NEW YORK, NY, 10036, US

(21) Appl. No.: 10/571,664

(22) PCT Filed: Sep. 13, 2004
(86) PCT No.: PCT/FR04/02323

§ 371 Date: May 3, 2006

(30) Foreign Application Priority Data
Sep. 11, 2003 (FR) 0310677

(51) Int. Cl. A01K 29/00

(52) U.S. Cl. 294/1.3

(57) ABSTRACT

The invention concerns a device for picking up animal waste, characterized in that it is provided with fixing elements to be arranged on a leash reel or integrated thereto in a single one-piece appliance and is composed of two articulated arms for collecting waste.

The invention concerns a device for picking up animal waste, adaptable or integrated to a leash equipped with a reel.

The pollution of public thoroughfares with animal waste is a familiar problem to all city-dwellers, and for decades municipalities and individuals—dog-owners and non-dog-owners alike—have been working to find solutions for this inconvenience, which continues to increase with the number of domestic animals.

To attempt to reduce dog pollution, some municipalities have enacted laws requiring people to keep dogs on leashes and clean up after them, while others are considering issuing fines for failure to clean up public thoroughfares fouled by animals. Other municipalities are attempting preventive action by installing dog waste clean-up bags next to trash cans, but the truth is that these devices, although effective, are insufficient in number and are often far from where the dog chooses to answer the call of nature. Even in these equipped? [question mark sic] locations, the proposed solution is not well adapted to the problem.

Quite obviously, an individualized pickup device that is easily transportable by dog-owners seems to be better adapted.

### PRIOR ART

Various systems have been proposed for picking up said waste without getting one's hands dirty; in particular, the documents FR 2 649 143 and U.S. Pat. No. 5,438,708 describe gloves that can be used as bags. However, these devices have not come into widespread use due to the natural aversion to grasping excrement in this manner, even through a glove.

Other devices generally making use of folded cardboard boxes have been proposed with more success, particularly those of the kind described in the documents FR 2 652 101, FR 2 686 634, FR 2 741 642, FR 2 747 135, U.S. Pat. No. 4,148,510 or U.S. Pat. No. 5,797,636. All of these devices are fairly simple and inexpensive and generally do not take up much space. They do have one major drawback, however: the dog-owner must remember to take them along, which is seldom the case.

Other more or less sophisticated systems have been described, such as, for example, a walking stick/bag in U.S. Pat. No. 4,236,741 and various devices installed on rods, for example those described in U.S. Pat. No. 4,951,987, U.S. Pat. No. 5,702,138, U.S. Pat. No. 5,868,447 or WO 9839517.

Two-part devices of the bag and scoop type—variants of the dustpan/whisk broom system—have been proposed; an example of this type of device is provided by U.S. Pat. No. 5,226,182.

All of these more or less complex “remote” pickup devices have several major drawbacks: they are expensive, and they transform an outing with the animal into an expedition, so cumbersome and ill-suited to emergency outings are the tools involved. As in the case of the simplified? [question mark sic] devices, the pickup tool may often be forgotten.

A better approach to the problem was attempted in GB 2 361 615. That document describes the combination of a leash and a container for carrying pickup boxes. Although that device evinces improvements over the prior art, waste pickup is not easy and the packages used are bulky, resulting in a cumbersome apparatus.

The object of the invention is, therefore, to resolve these principal difficulties by proposing a device that cannot be forgotten by the dog-owner, is easy to use, and makes pickup less disagreeable.

The present invention concerns a device for picking up animal waste, characterized in that it is provided with fixing elements to be arranged on a leash reel or alternatively is integrated therewith in a single, one-piece appliance, and is composed of two articulated arms for collecting waste. Said articulated arms support a disposable package used to collect the waste.

Other characteristics and advantages of the invention will emerge from the description that follows and an examination of the appended drawings, which are provided merely as non-limitative examples.

### DESCRIPTION OF THE DRAWINGS

FIGS. 1 to 4 present a specific exemplary embodiment according to the invention, in which the leash and its reel are integrated in a one-piece assembly.

FIG. 1 is a perspective view from below of the device for picking up animal waste in open position.

FIG. 2 is a view from below of the device in closed position.

FIG. 3 illustrates the opening and closing mechanism in a side elevation in section, the device being in open position.

FIG. 4 is a side view in section that shows the pickup device in closed position.

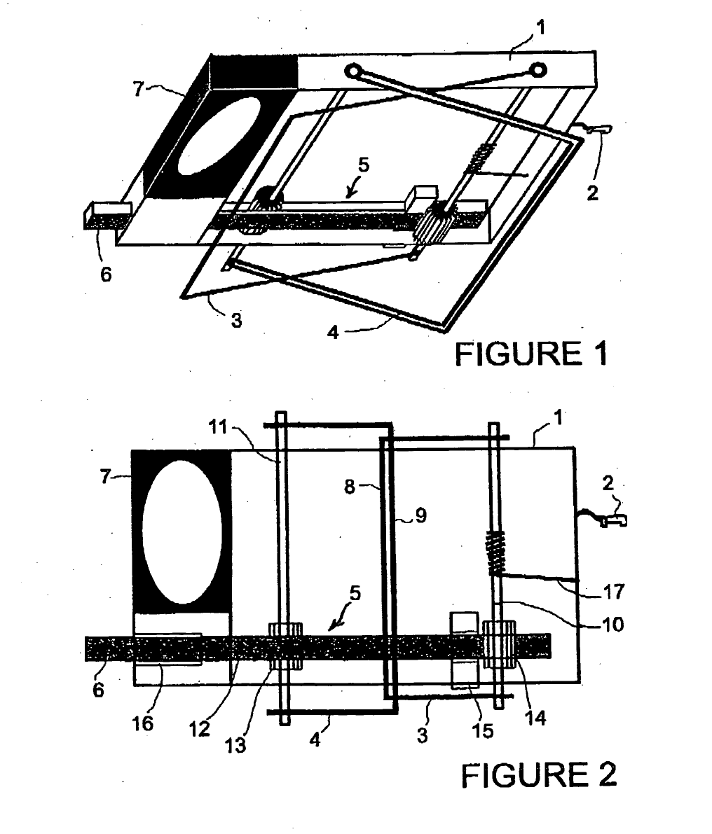

As FIG. 1 shows, the device for picking up animal waste is depicted in a perspective view from below in an open configuration, i.e., the articulated arms 3, 4 used for pickup are folded back against the apparatus.

The pickup device according to the invention is composed of the following essential elements:
an armature 1 serving to support the various constituent elements,
a leash 2 shown in FIG. 1 with its hook for attaching it to the animal's collar. The reel device integrated into armature I is not illustrated in the figures,
two articulated arms 3, 4 for picking up animal waste,
a mechanism 5 for opening and closing the device, with a pushbutton 6 to actuate it,
a handle 7 for holding the assembly firmly in the user's hand.

More precisely, and as illustrated in FIG. 2, the pickup device is configured in closed position with the two articulated arms 3, 4 outspread, with the ends 8, 9 of said arms in contact with each other. Said articulated arms are U-shaped and are solidly affixed to shafts 10 and 11, in such a way that when the shafts pivot, the arms simultaneously move. In this illustration example, arm 3 moves inside arm 4.

The space inside articulated arms 3, 4 is the useful pickup volume. This is due to the fact that according to the invention a disposable bag is affixed to the ends 8, 9 of the articulated arms, or alternatively is positioned in said space delimited by the movement of the arms, in such fashion as to collect the animal waste.

The disposable bag can be made of various materials, such as paper, plastic, nonwoven materials, flexible laminates, etc., and can have various shapes. However, the bag is preferably chosen from among the standard, small-capacity bags usable for various applications such as packaging and shipping, so as to be readily available at very low cost.

The winding-up device of the leash 2 is not detailed in FIGS. 1 to 4; this device is thoroughly conventional and can assume various forms, the chief of which is to wind the leash onto a central ring, with a spring serving to retract the leash. Such mechanisms are conventional and can be integrated into the pickup device in various forms.

According to the invention, the wind-up mechanism for the leash can either be integrated into the inside of the armature 1 to create a one-piece assembly or can be affixed to the outside of the pickup device, on the face opposite that of the articulated arms. This fixation can be lasting if permanent adhesive means such as glue, double-sided adhesives, etc. are used, or temporary if straps, “Velcro” fasteners or other fasteners are used. Said fixing means can be adjustable and, where appropriate, elastic.

According to the invention, the winding-up device or the fixation system of the leash is always disposed in the upper portion of the pickup device, opposite the articulated arms.

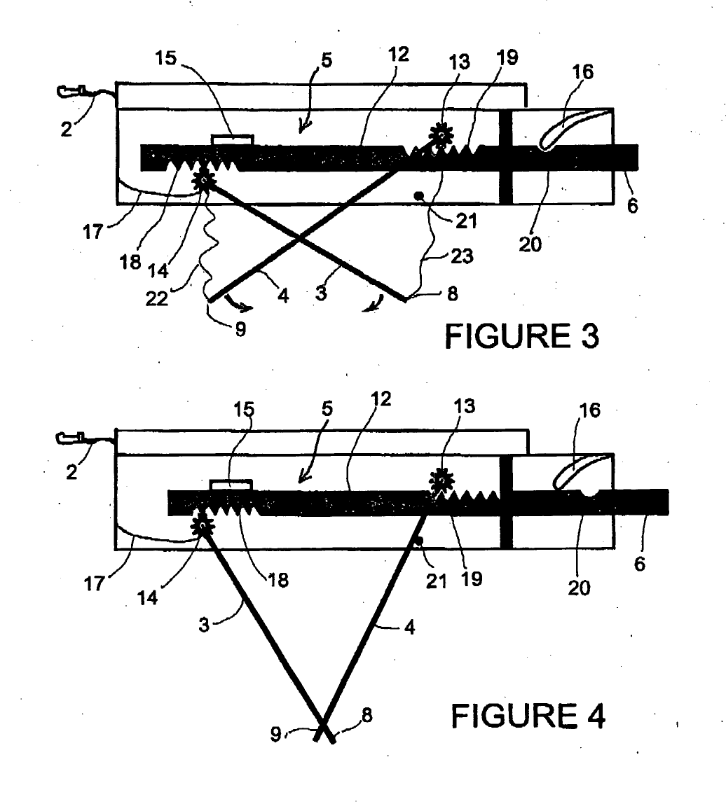

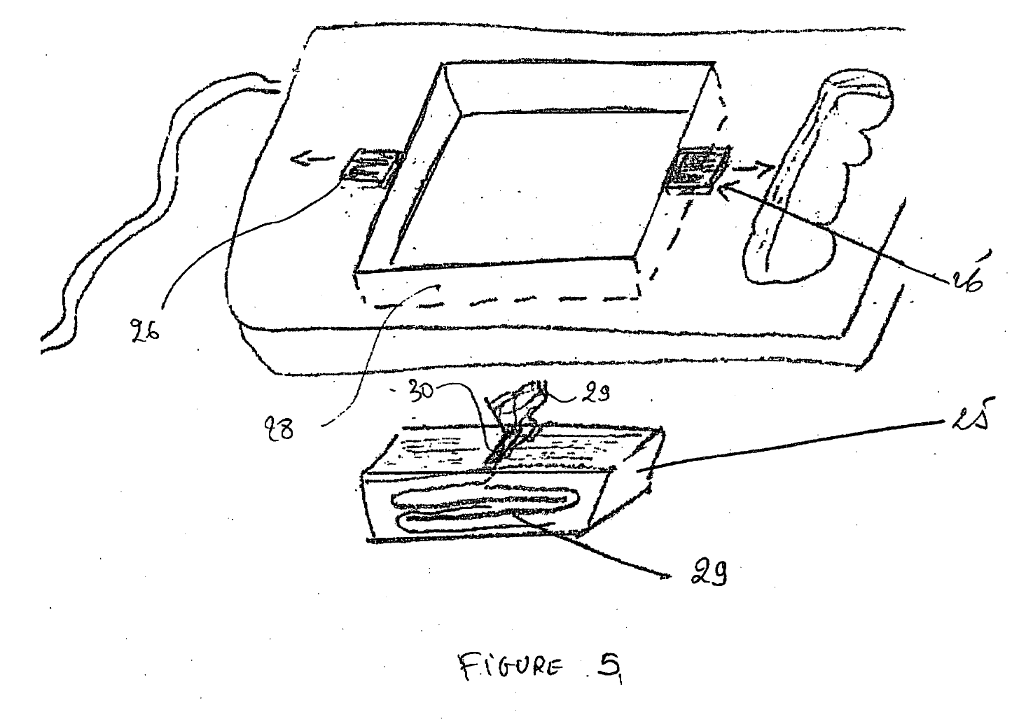

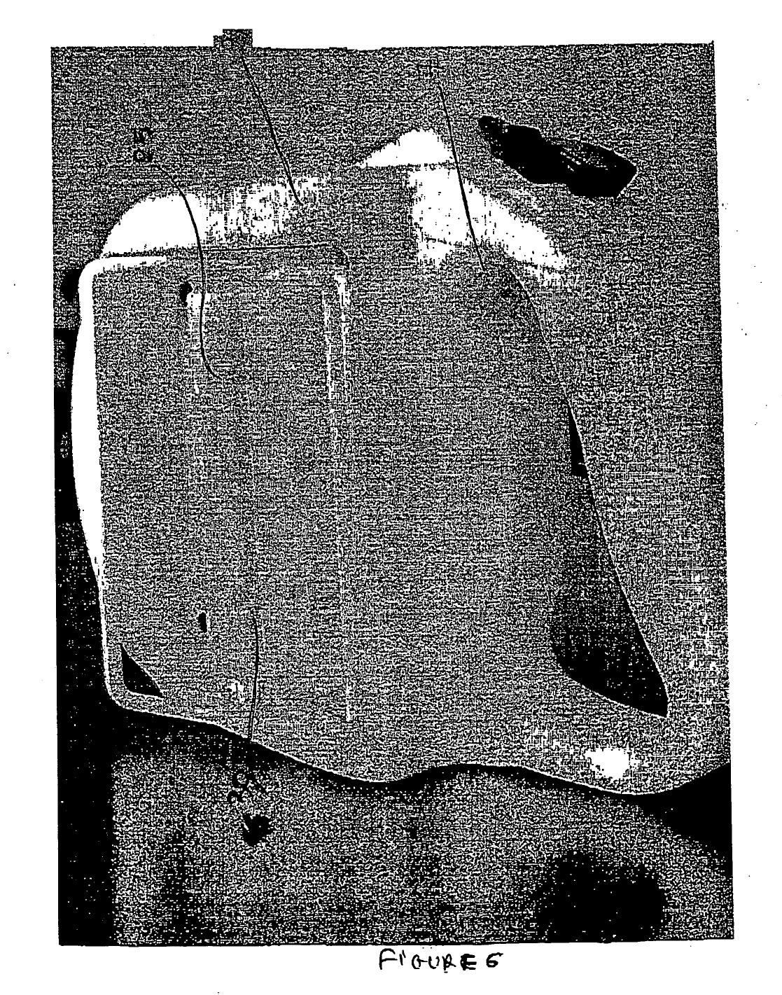

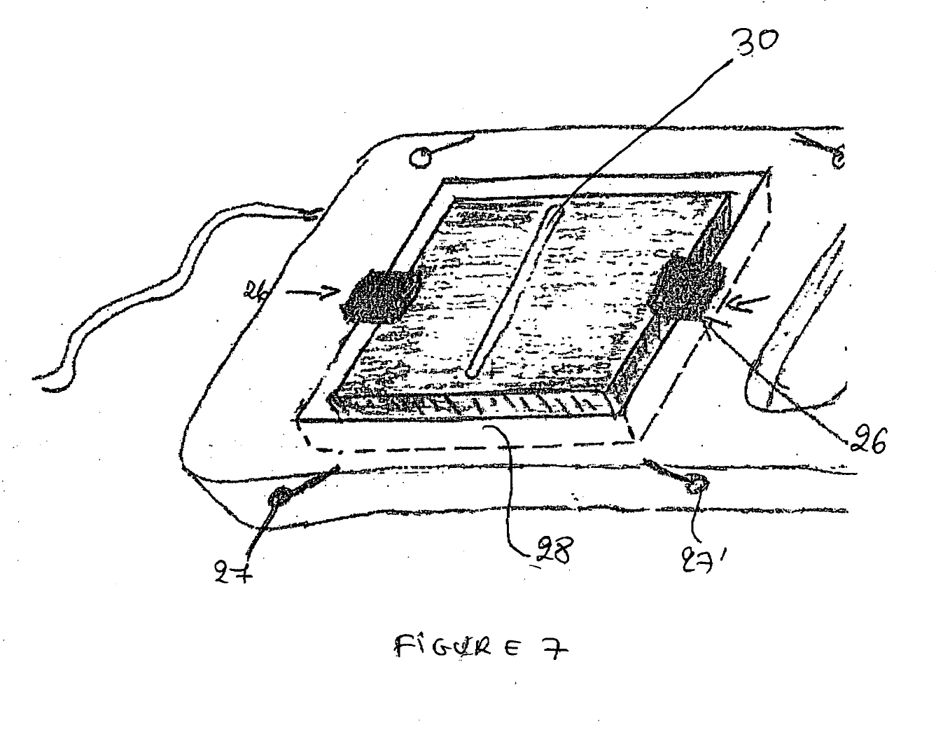

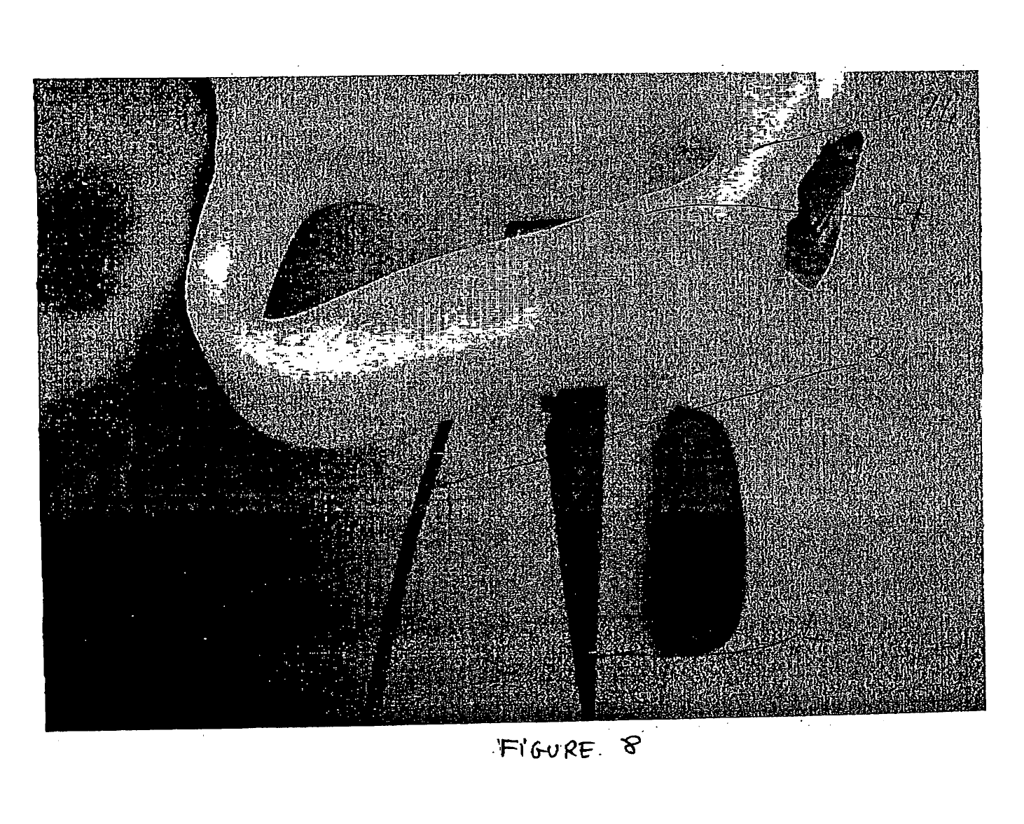

The operating mechanism of the device for picking up animal waste illustrated in the various figures comprises, in addition to the two articulated arms 3, 4 solidly affixed to shafts 10, 11, a gear rack 12 actuated by means of the pushbutton 6. Said gear rack is toothed over two portions of its length and on both of its faces, as illustrated in FIGS. 3 and 4.

The teeth 18, 19 carried by gear rack 12 interact with the teeth carried by toothed wheels 13, 14 solidly affixed to shafts 10, 11.

A return spring 17 the end of which is connected to armature 1 is solidly affixed to shaft 10, which spring serves to close the pickup device when the pushbutton is actuated.

A catch 16 allows the pickup device to be locked in open position, and operates in relation to the notch 20 carried by gear rack 12.

A guide 15 is disposed near the end of gear rack 12 so that the latter slides easily in its axis of movement and actuates the articulated arms.

The pickup apparatus is advantageously provided with a stop 21 that limits the rotation of articulated arm 4 during its movement.

Flexible elements 22 and 23, depicted only in FIG. 3, are connected on the one hand to shafts 10 and 11 and on the other hand to ends 8 and 9 of the articulated arms. Flexible element 22 connects shaft 10 and end 9, while flexible element 23 connects shaft 11 and end 8. Said flexible elements 22, 23 may be made of plastic or fabric, for example, and the function of these elements is to help contain waste when it has been gathered up in the disposable package fixed in the interior space of the pickup device.

According to the invention and in reference to FIGS. 3 and 4, the mechanism of operation of the device for picking up animal waste is as follows:
The apparatus, in open position, illustrated in FIG. 3, is locked by means of latch 16 inserted into notch 20 on gear rack 12. In this open position, the spring 17 is under tension.
A plastic bag is disposed in the interior space delimited by arms 3 and 4, said bag being affixed to ends 8 and 9 of the arms.
The apparatus is positioned on the waste with the plastic bag enveloping said waste.
Pushbutton 6 is actuated, which has the effect of releasing the strain on spring 17 and moving gear rack 12 backward. As a result, the articulated arms pivot in the direction indicated in FIG. 3, and the ends 8 and 9 of said arms come together to trap the waste in the disposable package.
The bag is ejected into a trashcan by actuating the pushbutton again, which has the effect of opening the articulated arms.

In the configuration represented by FIG. 4, flexible elements 22 and 23 are pulled taut within the planes of arms 3 and 4.

The invention has multiple advantages over the prior art:
the device is inexpensive,
the apparatus functions automatically to pick up and eject waste,
the device can be affixed to different models of leashes equipped with reels and can also be integrated with the leash reel in a one-piece system,
the apparatus is relatively unbulky and easily transportable on all outings with the animal,
the consumables represented by the plastic or paper bags are standard and inexpensive compared to cardboard boxes specially cut to constitute a disposable system,
the pickup device can be manipulated with just one hand.

As shown in the various figures, the handle 7 has been arranged so that the device can be used easily by a right-handed person, the pushbutton actuating the opening and closing mechanism being situated so that it is actuated with the thumb when the user has hold of the handle. A variant for a left-handed person or another position for the pushbutton is entirely feasible without departing from the ambit of the invention.

Plural variants of the waste pickup device are possible without departing from the ambit of the invention, the chief of which concerns the various possible configurations of leashes, with or without reels, in the apparatus. For instance, it can easily be envisaged to incorporate a link to a retractor, of which numerous variants exist.

The pickup device combined with the leash is susceptible to several variants as to the arrangement of the articulated arms, their relative positions, their dimensions, the devices for closing and opening said arms, with or without springs, with various means for releasing the arms, said means possibly being motorized and for example battery-operated, without departing from the ambit of the invention.

The types of materials used to make the pickup device, can, of course, vary widely. For economic reasons, for example an apparatus made primarily of molded plastic or a more robust apparatus made of aluminum may be contemplated without departing from the ambit of the invention.

One interesting variant of the invention concerns the possibility of fitting the armature of the pickup device with a system for attaching disposable bags as refills. To this end, it may be contemplated to dispose on the armature 1 a ring in the form of a payout reel, connected to both sides of the apparatus, so that a roll of plastic bags can be placed thereon. It is even conceivable for a box system containing refills to be disposed inside the frame, between the leash payout device and the articulated arms, so that the disposable bags can be withdrawn from the reserve supply through the vacant interior space of the apparatus in the same way as disposable handkerchiefs and wipes are withdrawn from their containers nowadays. In this case the bags are folded up and can be withdrawn either through a slit or through a star-shaped opening.

A device such as that described hereinabove is illustrated in FIG. 5. It comprises a case A provided with a central longitudinal aperture for withdrawing the bags. This case is normally left open, but it can be closed by an obturating device. It contains a multitude of bags disposed folded. These can be withdrawn one by one through the longitudinal slit in the manner of disposable handkerchiefs. Said case is secured to the handle of the leash reel by any method of attachment, particularly by means of screws or by being clipped on. As represented in FIG. 5, this box-type receptacle is disposed in a recess in the leash reel. The box-type receptacle is secured to said recess by means of a frame, to which is also affixed a closing device that flips over onto the central aperture. The closing device can have smooth edges or toothed edges to more easily sever the bag that is to be withdrawn.

A device of this kind is depicted in FIG. 6. That figure shows the bag case disposed in a recess in the handle. The bag box has a longitudinal slit 30 through which a series of bags can be withdrawn. This case is flush-mounted in the flat portion 24 of the handle of the leash. A variant of this device, not shown, consists in using a lidded box-type receptacle in which the bags are rolled up. One end of the first bag is inserted in the withdrawal aperture. The first bag can thus be withdrawn and torn off against the edge of the withdrawing device.

FIG. 7 depicts the arrangement of the bags in the receptacle. The figure shows a box-type receptacle 28, preferably of cardboard, containing the refill bags (not shown), a slit 26 enabling the bags to be taken out one by one, at 30 the exit slit for the bags and at 27, 27′, buttons to hold the bag refills in place. The fixing tabs are depicted at 26.

FIG. 8 shows part of the bag dispenser disposed in the handle of the leash. The figure includes the two articulated arms 3 and 4 used to pick up the waste.

Other variants of the invention concern the possibility of adding a locking device for the leash, which can be affixed to the leash, to the pickup device, or, by means of a hook, to the belt loop of the owner of the animal, for example. Such a device, which is very simple, advantageously improves the invention. During pickup the dog will often tug on the leash, making it precarious to pick up waste or dispose of the bag containing it. It is therefore desirable to secure that portion of the leash that is attached to the dog to a fixed point, preferably connected to the dog-owner, to free the pickup device from any inopportune traction. An appropriate fixing device can be for example a quick release fastener, a clip or any other securing means that can be fitted firmly to the leash and is provided with an additional connecting element such as a hook, snap, burr-type closure, etc., designed to be positioned on a belt loop, a belt or any other point that enables the dog-owner to be connected to his animal without having to hold onto the leash. There are, of course, numerous variants of this improvement in the operation of the pickup device, and such possibilities form part of the invention.

The invention naturally is not limited to the embodiments described and is illustrated by way of example. It also encompasses all the technical equivalents as well as the combinations thereof.

1. A device for picking up animal waste wherein
it is provided with fixing elements, which may be removable and/or adjustable, elastic where appropriate, such as straps, burr-type fasteners, etc., or which may be permanent, such as double-sided adhesive, glue, etc., to be disposed on a leash reel, or alternatively to be integrated with said leash reel in a single one-piece apparatus,
it is composed of two articulated arms for collecting the waste, which move in rotation, one arm moving inside the other, the ends of said arms being in contact in the closed position,
the opening or closing of the device is actuated by the pressure of the thumb on a pushbutton, which pushbutton is linked to the articulated arms by a gear rack and toothed wheels.

2. The device for picking up animal waste as recited in claim 1, wherein
the articulated arms support a disposable packaging unit used to collect the waste.

3. The device for picking up animal waste as recited in claim 1, wherein
the articulated arms are actuated for closing and for collecting animal waste by means of an automated or motorized mechanism.

4. The device for picking up animal waste as recited in claim 1, wherein
the articulated arms are actuated for opening and for releasing the collected waste by means of an automated or motorized mechanism.

5. The device for picking up animal waste as recited in claim 3, wherein
the automated or motorized mechanism is a spring device.

6. The device for picking up animal waste as recited in claim 2, wherein
said disposable packaging unit is a bag made of plastic, paper or a nonwoven material.

7. The device for picking up animal waste as recited in claim 2, wherein
the disposable packaging units serving as refills, for example in the form of rolls or of folded bags integrated into boxes, are positioned by means of a system affixed to the outside of the pickup device or integrated therein.

8. The device for picking up animal waste as in claim 2, wherein
the disposable packaging units serving as refills are disposed in a box-type receptacle disposed in a recess of the leash reel that is provided with a central aperture optionally equipped with a movable obturating device.

9. The device for picking up animal waste as recited in claim 2, wherein
the disposable packaging units serving as refills are disposed folded one on top of the other to permit single withdrawal through the central aperture.

10. The device for picking up animal waste as recited in claim 2, wherein
the disposable packaging units are wound around a shaft and the end of the first package is engaged in an aperture perforated in the receptacle through which it can be withdrawn.
